(19) United States
(12) Patent Application Publication
(10) Pub. No.: US 2022/0044029 A1
(43) Pub. Date: Feb. 10, 2022

(54) Method for Recognizing an Object from Input Data Using Relational Attributes

(71) Applicant: Robert Bosch GmbH, Stuttgart (DE)

(72) Inventors: Matthias Kirschner, Hildesheim (DE); Thomas Wenzel, Hildesheim (DE)

(21) Appl. No.: 17/394,887

(22) Filed: Aug. 5, 2021

(30) Foreign Application Priority Data
Aug. 6, 2020 (DE) 10 2020 209 983.9

(51) Int. Cl. G06K 9/00; G06K 9/62; G06K 9/46; G06K 9/34; B60W 60/00; G01S 13/42; G01S 13/931; G06N 3/02

(52) U.S. Cl. CPC G06K 9/00791; G06K 9/6261; G06K 9/4638; G06K 9/34; B60W 60/001; B60W 2554/40; G01S 13/931; G06N 3/02; B60W 2420/42; B60W 2420/52; B60W 2420/54; G01S 13/42

(57) ABSTRACT

A method for recognizing an object from input data is disclosed. Raw detections are carried out in which at least two objects are determined. At least one relational attribute is determined for the at least two objects. The at least one relational attribute defines a relationship between the at least two objects. An object is recognized taking account of the at least one relational attribute.

This application claims priority under 35 U.S.C. § 119 to application no. DE 10 2020 209 983.9, filed on Aug. 6, 2020 in Germany, the disclosure of which is incorporated herein by reference in its entirety.

### TECHNICAL FIELD

The disclosure relates to a method for recognizing an object from input data using relational attributes. The disclosure furthermore relates to an object detection apparatus. The disclosure furthermore relates to a computer program product.

### BACKGROUND

Known object detection algorithms yield a set of detections for an input datum (e.g. in the form of an image). A detection is generally represented by a rectangle bounding the object (bounding box) and a scalar detection quality.

Alternative forms of representation, such as, for example, so-called principal points, for instance the positions of individual body parts such as head, left/right arm, etc., are known in the case of a person detector. What is problematic in the case of object recognition is the identification of objects which are arranged within a group and are partly concealed by other objects of the group. This is of interest particularly when tracking objects, for example persons in a crowd, or when observing a traffic volume of road traffic from the perspective of the driver of a vehicle.

### SUMMARY

It is an object of the disclosure in particular to provide a method for recognizing objects by means of input data in an improved manner.

The object is achieved in accordance with a first aspect by a method for recognizing an object from input data, comprising the following steps:
a) carrying out raw detections, wherein at least two objects are determined;
b) determining at least one relational attribute for the at least two objects determined, wherein the at least one relational attribute defines a relationship between the at least two objects determined in step a); and
c) determining an object to be recognized taking account of the at least one relational attribute.

In this way, an object recognition is realized which uses a specific class of attributes in the form of so-called “relational attributes”. The relational attributes no longer relate just to a single object, but rather to one or more other objects and thus define a relationship between at least two different objects. A relational attribute is an attribute of the detection which describes a relationship between a detected object and other objects. By way of example, the number of objects in a specific radius around a detected object can constitute a relational attribute. The relationship described is the spatial proximity of the objects in the image space. Moreover, an interaction between objects can constitute a relational attribute. By way of example, the person recognized in detection A may be talking to another recognized person B. Talking is the relational attribute.

Advantageously, an improved object recognition can thereby be carried out and e.g. efficient control signals for a physical system, e.g. a vehicle, can thereby be generated as a result. By way of the object recognition with relational attributes, for a determined object it is possible to ascertain for example a number of objects that are at least partly concealed by the determined object. This can be processed further as additional information for the determined object. By way of example, vehicles driving one behind another or pedestrians walking one behind another or bicycles or motorcycles traveling one behind another can be recognized thereby.

Raw detections are within the meaning of the application detected objects which are predicted with at least one attribute. The at least one attribute can be given by a bounding element, a bounding box, which at least partly encompasses the detected objects. Furthermore, a confidence value can be assigned to a raw detection as a further attribute. In this case, a confidence value indicates the degree of correspondence between the bounding box and the detected object. Furthermore, a raw detection can have additional attributes, which within the meaning of the application are related exclusively to the detected object, however, and thus differ from the relational attribute in that no statements about further objects possibly at least partly concealed by the detected object of the raw detection can be made by way of the attributes of the raw detection.

In accordance with a second aspect, a method for controlling an autonomously driving vehicle taking account of environment sensor data is provided, wherein the method comprises the following steps:

capturing environment sensor data by way of at least one environment sensor of the vehicle;

recognizing an object on the basis of the captured environment sensor data in the form of input data taking account of at least one relational attribute;

determining, taking account of the recognized object, a surroundings state of the vehicle, wherein at least one traffic situation of the vehicle including the recognized object is described in the surroundings state;

generating a maneuvering decision by means of the control module of the vehicle control, wherein the maneuvering decision is based on the surroundings state determined;

effecting, by means of control systems of the vehicle control, a control maneuver on the basis of the maneuvering decision.

The maneuvering decision can comprise braking or accelerating and/or steering of the vehicle. As a result, it is possible to provide an improved control method for autonomous vehicles which is based on an improved object recognition.

In accordance with a third aspect, the object is achieved by an object detection apparatus configured to carry out the proposed method.

In accordance with a fourth aspect, the object is achieved by a computer program comprising instructions which, when the computer program is executed by a computer, cause the latter to carry out the proposed method, or which is stored on a computer-readable storage medium.

The embodiments relate to preferred developments of the method.

A further advantageous development of the method is distinguished by the fact that the relational attribute is one of the following: interactions of at least two objects, concealment of one object by at least one other object. Useful forms of relational attributes which define a functional relationship between at least two different objects are provided in this way. As a result, it is possible to recognize an unambiguous relation between two or more objects, thereby enabling an assessment of how many possibly partly concealed objects are contained in a raw detection.

Further advantageous developments of the method are distinguished by the fact that a bounding element or principal points of the object are determined as an attribute for locating the object. This advantageously provides various possibilities for defining or locating the object by means of the input data.

A further advantageous development of the method is distinguished by the fact that the attribute in the form of a bounding element is subdivided into partial bounding elements, wherein a binary value is determined for each partial bounding element, said binary value encoding a presence of an object within a partial bounding element. A further type of the relational attributes is advantageously provided in this way, which can provide a further improved scene resolution under certain circumstances.

A further advantageous development of the method is distinguished by the fact that the method is carried out with at least one type of the following input data: image data, radar data, lidar data, ultrasonic data. Advantageously, the proposed method can be carried out with different types of input data in this way. An improved diversification or useability of the proposed method is advantageously supported in this way.

A further advantageous development of the method is distinguished by the fact that a neural network, in particular a convolutional neural network CNN, is used for determining the relational attribute, wherein an image of the input data is convolved with defined frequency at least in partial regions by means of convolutional kernels of the neural network. Advantageously, the relational attributes can be determined with only slightly increased computational complexity in this way. In the neural network used, the relational attribute can be taken into account at least in the form of an additional output neuron of the neural network that describes the relational attribute. The neural network, in a preceding training method, was correspondingly trained to output the relational attribute at the additional output neuron.

A further advantageous development of the method is distinguished by the fact that determining the object to be recognized is carried out together with non-maximum suppression. As a result, the relational attribute can also be used in association with non-maximum suppression, whereby an object recognition can be improved even further.

A further advantageous development of the method is distinguished by the fact that a control signal for controlling a physical system, in particular a vehicle, is generated depending on the recognized object. As a result, a better perception of an environment is thereby supported, whereby a physical system, e.g. a vehicle, can be controlled in an improved manner By way of example, an overtaking maneuver of a vehicle after a plurality of vehicles ahead have been recognized can thereby be controlled in an improved manner.

According to one embodiment, the control maneuver is an evasive maneuver and/or an overtaking maneuver, and wherein the evasive maneuver and/or the overtaking maneuver are/is suitable for steering the vehicle past a recognized object.

The disclosure is described in detail below with further features and advantages with reference to several figures. In this case, identical or functionally identical elements have identical reference signs.

Disclosed method features are evident analogously from corresponding disclosed apparatus features, and vice versa. This means, in particular, that features, technical advantages and explanations concerning the proposed method are evident analogously from corresponding explanations, features and advantages concerning the proposed object detection apparatus, and vice versa.

### BRIEF DESCRIPTION OF THE DRAWINGS

In the figures:

FIG. 1 shows a basic sequence of the proposed method;

FIG. 2 shows a block diagram of a proposed object detection apparatus;

FIG. 3 shows a basic illustration of a mode of functioning of the proposed method;

FIG. 4 shows a basic sequence of a proposed training method for training relational attributes;

FIG. 5 shows an example for determining a relational attribute by means of a neural network; and

FIG. 6 shows a basic sequence of one embodiment of the proposed method.

### DETAILED DESCRIPTION

It is known to predict object-specific attributes such as a degree of overlap of a detection with the detected object entity or object properties such as, for example, the orientation of an object in the scene. This is disclosed e.g. in Redmon, Joseph, et al. “You only look once: Unified, real-time object detection”, Proceedings of the IEEE conference on computer vision and pattern recognition, 2016 or in Braun, Markus, et al. “Pose-RCNN: Joint Object Detection and Pose Estimation Using 3D Object Proposals”, IEEE ITSC, 2016.

A central concept of the proposed method is a prediction of so-called relational attributes, in particular in association with object detection. The proposed relational attributes describe relationships or properties which relate to one or more further objects in the environment of a detected object. This also comprises an algorithmic procedure which follows the object detection and which assesses e.g. the attribute presence in respect of object proposals. These attributes are referred to hereinafter as “relational attributes”. Conventional attributes relate exclusively to properties of the detected object. Such conventionally detected objects are thus considered in isolation; potentially important context information is thus not made available to post-processing.

One simple example of a relational attribute is a number of objects which overlap the detected object in an image space. By way of example, it could be predicted for a vehicle that the latter is concealing two further vehicles ahead, only a small percentage of said further vehicles being visible in the image on account of concealment.

In this way, with the proposed method it is possible to obtain a considerably improved understanding of scenes or it is possible to support subsequent algorithms, by informing for example downstream non-maximum suppression (NMS) of how many raw detections must be output within a specific region. Alternatively, the determined relational attributes of a determined object can also serve as additional information with regard to the determined object for an improved object recognition. In this respect, for example, on the basis of the relational attributes of a recognized object, the recognized object can be recognized as an object associated with a group of objects. By way of example, from a perspective of a driver of a vehicle, a further vehicle disposed in front of said vehicle can thus be recognized as belonging to a group of further vehicles disposed one behind another. Series of vehicles driving one behind another can thereby be determined, wherein a position within the series can be assigned to each recognized vehicle by ascertaining the number of vehicles which are at least partly concealed by the respective vehicle. This may be of interest for a planned overtaking procedure, in particular, in which, for the overtaking vehicle, it is necessary to take account of whether only the vehicle disposed directly in front of the overtaking vehicle or a series of further vehicles driving one behind another must be overtaken. The information of the relational attributes can be taken into account accordingly by the control of the vehicle.

Further conceivable possibilities for application of the proposed method are:

An algorithm for person recognition or action recognition can be assisted by the prediction of concealment information of body parts, for instance, in order to focus on the correct object. Additionally predicted concealment information can advantageously enable a tracking algorithm that tracks an object in a video sequence with the support of an object detector to correctly take difficult algorithmic decisions, such as opening up new tracks proceeding from individual detections, in order in this way to improve e.g. the tracking behavior of crowds of people.

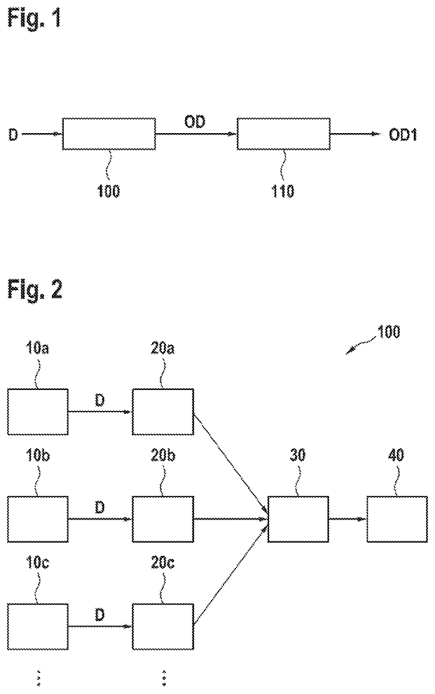

FIG. 1 shows a sequence of the proposed method in principle. It reveals an object detection apparatus 100, for example having a processing device 20a . . . 20n (not illustrated), to which input data D in the form of e.g. camera data, lidar data, radar data, ultrasonic data, environment of a vehicle are fed. In this case, the input data D can be represented in an image-like form in a 2D grid or a 3D grid.

In the case of the raw detections, it is proposed to determine an attribute 1a . . . 1n in the form of at least one relational attribute 1a . . . 1n which defines a relationship between a determined object and at least one further determined object.

Consequently, the raw detections carried out in this way either are available as first object detections OD or can optionally be transferred to downstream non-maximum suppression, which is carried out by means of a suppression device 110. As a result, second object detections OD1 with the recognized objects are thereby provided at the output of the suppression device 110. By means of the non-maximum suppression (NMS), an arising plurality of detections per target object can be reduced to a single detection. By taking account of the relational attributes determined, it is possible to ascertain whether only one object or a group of objects partly concealing one another is recognized. This can be taken into account in the non-maximum suppression in order to attain as unambiguous a representation as possible of the recognized object or of the recognized objects by means of one or more bounding elements, in the form of bounding boxes.

By means of the object detection apparatus 100, raw detections are carried out from the input data D, wherein assigned attributes 1a . . . 1n (e.g. bounding elements, confidence, object classifications, etc.) are determined. An attribute 1a . . . 1n for defining an object from the input data D can be present for example in the form in the form of a bounding element (bounding box) of the object, which encloses the object as a kind of rectangle.

Alternatively, provision can be made for defining the object from the input data D in the form of principal points, wherein each principal point encodes the position of an individual component of an object (e.g. head, right/left arm of a person, etc.). Thus, improved attributed raw detections are carried out with the proposed method, wherein at least one additional attribute (e.g. concealment) is taken into account per principal point. A description is given below by way of example of two variants as to how such raw detections attributed in an improved manner can be carried out. In the form of semantic segmentation, therefore, individual components can be ascribed to each recognized object. By way of example, individually recognized body parts can be assigned as principal points to a recognized person. Such an assignment of individual components of an object can be achieved by means of a neural network trained for semantic segmentation and classification of objects. A corresponding training process is effected according to training processes known from the prior art for semantic segmentation and object recognition. For this purpose, the neural network can be embodied for example as a convolutional neural network.

One embodiment of a proposed object detection apparatus 100 is illustrated schematically in FIG. 2. A plurality of sensor devices 10a . . . 10n (e.g. lidar, radar, ultrasonic sensor, camera, etc.) are evident, which for example are installed in a vehicle and are used for providing input data D. Advantageously, a technical system operated with the proposed method can in this way provide different types of input data D, for example in the form of camera data, radar data, lidar data, ultrasonic data.

The relational attributes 1a . . . 1n mentioned can be determined for input data D of a single sensor device 10a . . . 10n or for input data D of a plurality of sensor devices 10a . . . 10n, wherein in the latter case the sensor devices 10a . . . 10n should be calibrated with respect to one another.

Connected downstream of each of the sensor devices 10a . . . 10n there is evident a respectively assigned processing device 20a . . . 20n that may comprise a trained neural network (e.g. region proposal network, convolutional neural network), which processes the input data D provided by the sensor devices 10a . . . 10n by means of the proposed method and subsequently feeds them to a fusion device 30. By means of the fusion device 30, the object recognition is carried out from the individual results of the processing devices 20a . . . 20n.

An actuator device 40 of a vehicle can be connected to an output of the fusion device 30, which actuator device is driven depending on the result of the object recognition carried out, for example in order to initiate an overtaking procedure, braking procedure, steering maneuver of the vehicle, etc. As explained above, the improved object recognition taking account of corresponding relational attributes of the recognized objects enables an improved and more precise control of a vehicle.

Some examples of relational attributes 1a . . . 1n and their application are mentioned below:
the raw detections can be represented with attributes 1a . . . 1n in the form of bounding elements (bounding box). In addition to the bounding elements, a prediction of how many objects intersect the bounding element is given as a relational attribute 1a . . . 1n for each object. While the predicted bounding element relates only to an individual object, the relational attribute indicates additional information which can advantageously be used in post-processing, e.g. in the non-maximum suppression already mentioned.
The raw detections can also be represented with attributes 1a . . . 1n in the form of principal points of the objects. Together with one, a plurality or all of the principal points, a relational attribute 1a . . . 1n is defined which indicates whether the principal point is concealing another object. In a manner similar to that in the preceding example, this information can advantageously be used in post-processing, which can be even more fine-grained.

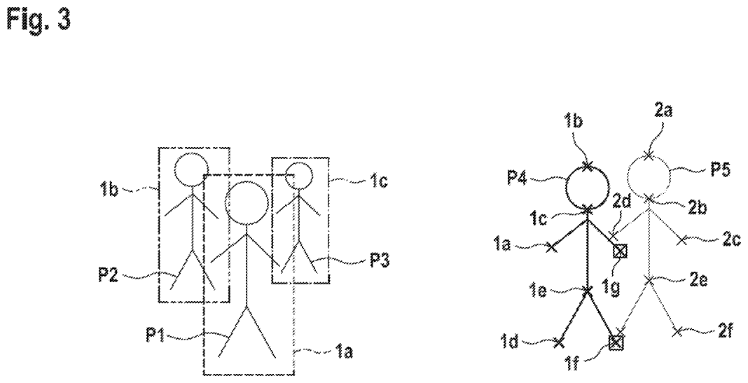

FIG. 3 shows examples of the proposed relational attributes 1a . . . 1n. The left-hand section of FIG. 3 indicates that the object detection apparatus 100 recognizes a respective person P1, P2, P3 by means of a respective bounding element 1a, 1b, 1c. In addition, how many objects there are in the object bounding element is predicted or determined as a relational attribute for each bounding element 1a, 1b, 1c.

As a result, this indicates how many persons are apparently situated within the respective bounding element. This means that, in the case of the bounding element 1a, the fact that a total of three persons are situated within the bounding element 1a is indicated as a relational attribute. In the case of the bounding element 1b, the fact that a total of two persons are situated within the bounding element 1b is indicated as a relational attribute. In the case of the bounding element 1c, the fact that a total of two persons are situated within the bounding element 1c is indicated. As a result, it is possible to achieve a more precise assignment of bounding elements to recognized objects and, in association therewith, an improved object recognition.

An encoding of the relational attributes mentioned can be carried out, e.g. in the form of numerical values. This means that the numerical value 3 is encoded for the bounding element 1a, the numerical value 2 for the bounding element 1, and likewise the numerical value 2 for the bounding element 1c.

The right-hand section of FIG. 3 indicates that two persons P4, P5 are recognized by means of the object detection apparatus 100, said persons not being represented by bounding elements (as in the left-hand section of FIG. 3), but rather in each case by attributes in the form of principal points 1a . . . 1n, 2a . . . 2n. With respect to each of said principal points 1a . . . 1n, 2a . . . 2n, the fact of whether or not this principal point is concealing another object is predicted as a relational attribute. By way of example, two principal points 1f, 1g of the person P4 to whom this is applicable are emphasized graphically. With the principal points 1f, 1g the person P4 is thus at least partly concealing the determined person P5.

A conceivable option not illustrated in the figures is the option that an attribute 1a . . . 1n in the form of a bounding element is subdivided into a plurality of partial bounding elements, wherein the fact of whether objects are situated in the respective partial bounding element is encoded in the partial bounding elements. The encoding can be effected in binary fashion with zeros or ones, for example, wherein a “1” encodes the fact that there is a further object situated in the partial bounding element, and wherein a “0” encodes the fact that there is no further element situated in the respective partial bounding element. An encoding in the form of an integer can indicate e.g. that there is more than one object situated in the partial bounding element.

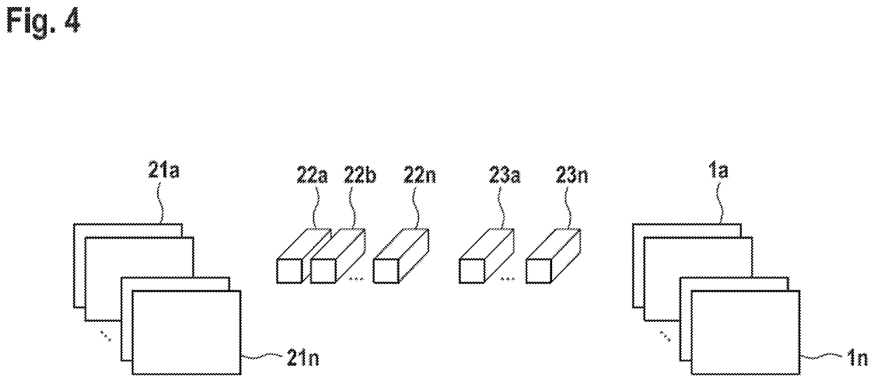

FIG. 4 shows an exemplary inference process of an object detection apparatus 100 with additional prediction of relational attributes 1a . . . 1n. In this case, the procedure adopted is analogous to that in the case of the prediction of attributes 1a . . . 1n in the form of bounding elements relative to anchors (predefined boxes within the meaning of the prior art document cited above) in that a prediction of the anchor value is determined for each anchor by means of one filter kernel 23a . . . 23n per relational attribute. If an anchor position lacks an object in accordance with predicted class confidence, then the prediction result is discarded.

FIG. 4 can also be understood as a training scenario of a neural network of a processing device 20a . . . 20n (not illustrated) for an object detection apparatus 100 (not illustrated), wherein the neural network can be embodied as a faster RCNN in this case. A plurality of feature maps 21a . . . 21n with input data D are evident. It is evident that the feature maps 21a . . . 21n are processed step by step by first convolutional kernels 22a . . . 22n and then by second convolutional kernels 23a . . . 23n. The images of the input data D that have been convolved in such a way constitute abstracted representations of the original images in this way. The proposed additional relational attributes 1a . . . 1n are determined by the convolutional kernels 23a . . . 23n in particular.

A result of the convolution of the feature maps by the convolutional kernels 22a . . . 22n, 23a . . . 23n is output at the output of the neural network. The relational attributes 1a . . . 1n that have been determined in such a way are subsequently processed analogously to coordinates of attributes 1a . . . 1n in the form of bounding elements.

In the training phase of the neural network, the additional relational attributes 1a . . . 1n can be generated e.g. manually by a human annotator, or algorithmically. For this purpose, the annotator can annotate corresponding relational attributes in the respective training data of the neural network. By way of example, the annotator can identify regions of concealment of objects in training data constituting image recordings. These identified image recordings are used as training data in order to train a neural network to recognize concealments of objects. Training data used can be, for example, image recordings which are recorded from a driver's perspective and which represent e.g. series of vehicles driving one behind another, in which concealments of individual vehicles can be identified.

By this means, a complete object annotation describes an individual object that appears in the image recording by way of a set of attributes, such as, for example, the bounding box, an object class, or further attributes suitable for identifying the object. These attributes can be suitable in particular for reducing, by means of non-maximum suppression (NMS) for a detected object, the plurality of raw detections created for object detection to the raw detection which enables the best representation of the detected object. All attributes required in the non-maximum suppression can correspondingly be stored in the annotations. These annotations of the attributes and also of the additional attributes can be performed manually during a supervised training process. Alternatively, such an annotation can be achieved automatically by means of a corresponding algorithm.

In the training process of the neural network, the free parameters (weights of the neurons) of the neural network are determined by means of an optimization method. This is done by defining a target function for each attribute predicted by the neural network, said target function punishing the deviation of the output from the training annotations. Accordingly, additional target functions are defined for the relational attributes. In this case, the target function specifically to be chosen is dependent on the semantics of the relational attribute.

If object annotations with attributes 1a . . . 1n in the form of bounding elements are already present, for example, a relational attribute describing how many objects an object overlaps could be determined in an automated manner by calculating the overlap between the bounding element and all other bounding elements in the scene. It should be taken into consideration here that although it is possible to calculate this information in an automated manner in the training phase with correct annotations being present, it is not possible to do so at the time of application of the object detection apparatus 100, since the output of the trained object detection apparatus 100 may exhibit errors and since in particular object detectors in accordance with the prior art produce far too many detections before the NMS is applied.

In order to take account of the additional relational attributes, for each relational attribute, a neural network of the object detection apparatus 100 can be provided at least with a further output neuron. The further output neuron outputs a relational attribute defined according to the training.

The relational attributes 1a . . . 1n of the object detection apparatus 100 that have been determined in the manner mentioned can advantageously be combined with non-maximum suppression. In this regard, for example, the information that an object is concealing further objects can be used to better resolve object groups into second object detections OD1 during the subsequent non-maximum suppression. However, the use of the relational attributes 1a . . . 1n proposed is advantageously not restricted to a combination with the non-maximum suppression, but rather can also be effected without the latter.

In this case, a relational attribute is defined as an attribute of the detection which describes a relationship between a detected object and other objects in the captured scene. Examples of a relational attribute are:
A number of a plurality of objects in a specific radius around the detection. In this case, said relationship is a spatial proximity of the objects in the image space.
An interaction between objects, e.g. a person recognized in a raw detection A is talking to another person recognized in a raw detection B.

In order to realize the proposed method, the relational attributes should already be taken into account in the training phase of the object detection apparatus 100. In this case, the object detection apparatus 100 is trained on a set of training data. In this case, the training data represent a set of sensor data (e.g. images), wherein a list of object annotations is associated with each datum. In this case, an object annotation describes an individual object that appears in the scene by way of a set of attributes 1a . . . 1n (e.g. bounding element, object class, detection quality, etc.). Relational attributes are correspondingly added to these attribute sets. On the basis of this training data—provided with object annotations—in the form of image recordings of scene representations of objects to be recognized, the object detection apparatus comprising at least one neural network is trained to recognize corresponding objects and the relational attributes respectively annotated.

The disclosure is advantageously applicable to products in which an object detection is carried out, such as, for example:
“intelligent” cameras for (partly) automated vehicles. In this case, the detection enables the recognition of obstacles or more generally an interpretation of the scene and the driving of a correspondingly controlling actuator
robots that evade obstacles on the basis of camera data (e.g. autonomous lawnmowers)
monitoring cameras that can be used to estimate e.g. the number of persons in a specific region
intelligent sensors in general that carry out an object detection on the basis of radar or LIDAR data, for example, that uses attributes determined by a camera, for example, in a further manifestation.

The proposed method can be used particularly beneficially in scenarios with greatly overlapping objects and in this way can resolve, e.g. individual persons in crowds of people or individual vehicles in a congestion situation. Advantageously, a plurality of objects are thereby not incorrectly combined to form a single detection.

Advantageously, it is thereby possible to facilitate work for algorithms downstream of the object detection, such as e.g. methods for person recognition. In this case, individual persons can be separated by the object detector, such that the person recognition in turn achieves optimum results.

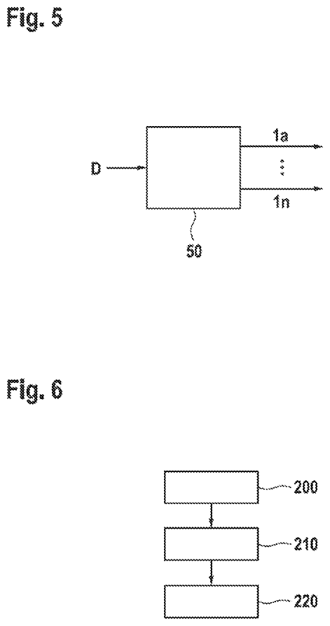

FIG. 5 shows a device in the form of a neural network for determining the relational attribute 1a . . . 1n proposed. It is evident that the input data D are fed to the neural network 50 in an inference phase of the object detection, wherein the neural network e.g. carries out the actions in accordance with FIG. 4 and determines the relational attribute 1a . . . 1n from the input data D.

In this case, the relational attribute 1a . . . 1n defines a relationship or relation between at least one determined object of the object detection.

In this way, a deep learning-based object detection is realized with the use of at least one neural network, in particular a convolutional neural network CNN, which firstly transforms the input data into so-called features by means of convolutions and nonlinearities in order, on the basis thereof, with specially arranged prediction layers of the neural network (usually likewise consisting of convolutional kernels, but sometimes also “fully connected” neurons), to predict inter alia a relational attribute, an object class, an accurate position and optionally further attributes.

Advantageously, the proposed method can be used e.g. in an object recognition system in association with action recognition/prediction, tracking algorithm.

FIG. 6 shows a basic flow diagram of one embodiment of the proposed method.

A step 200 involves carrying out raw detections, wherein at least two objects are determined.

A step 210 involves determining at least one relational attribute for the at least two objects determined, wherein the at least one relational attribute defines a relationship between the at least two objects determined in step a).

A step 220 involves determining an object to be recognized taking account of the at least one relational attribute.

The proposed method is preferably embodied as a computer program having program code means for carrying out the method on the processing device 20a . . . 20n. Advantageously, the proposed method can be implemented on a hardware chip, a software program being emulated by means of a chip design explicitly for a computational task of the proposed method.

Although the disclosure has been described above on the basis of concrete exemplary embodiments, the person skilled in the art can also realize embodiments not disclosed or only partly disclosed above, without departing from the essence of the disclosure.

What is claimed is:

1. A method for recognizing an object from input data, the method comprising:
a) carrying out raw detections in which at least two objects are determined;
b) determining at least one relational attribute for the at least two objects, the at least one relational attribute defining a relationship between the at least two objects; and
c) determining an object to be recognized based on the at least one relational attribute.

2. The method according to claim 1, wherein the at least one relational attribute is one of (i) interactions of at the at least two objects and (ii) concealment of one of the at least two objects by another of the at least two objects.

3. The method according to claim 1 further comprising:
determining, as an attribute for locating the object to be recognized, one of (i) a bounding element of the object to be recognized and (ii) principal points of the object to be recognized.

4. The method according to claim 3 further comprising:
subdividing the bounding element into partial bounding elements; and
determining, for each respective one of the partial bounding elements, a binary value that encodes a presence of the first object within the respective one of the partial bounding elements.

5. The method according to claim 1, wherein the input data include at least one of (i) image data, (ii) radar data, (iii) lidar data, and (iv) ultrasonic data.

6. The method according to claim 1, the b) determining the at least one relational attribute further comprising:
determining the at least one relational attribute using a neural network.

7. The method according to claim 1, the c) determining the object to be recognized further comprising:
determining the object to be recognized using non-maximum suppression.

8. The method according to claim 1 further comprising:
generating a control signal for a physical system based on the determined object to be recognized.

9. A method for controlling an autonomously driving vehicle taking account of environment sensor data, the method comprising:
capturing environment sensor data using at least one environment sensor of the autonomously driving vehicle;
recognizing an object based on the captured environment sensor data, the object being recognized by a) carrying out raw detections in which at least two objects are determined, b) determining at least one relational attribute for the at least two objects, the at least one relational attribute defining a relationship between the at least two objects, and c) determining an object to be recognized based on the at least one relational attribute.
determining, taking account of the recognized object, a surroundings state of the autonomously driving vehicle using a control module of the autonomously driving vehicle, the surroundings state describing at least one traffic situation of the autonomously driving vehicle including the recognized object;
generating, using the control module, a maneuvering decision based on the surroundings state; and
effecting, using control systems of the autonomously driving vehicle, a control maneuver based on the maneuvering decision.

10. The method according to claim 9, wherein the control maneuver is at least one of an evasive maneuver and an overtaking maneuver which is configured to steer the autonomously driving vehicle past the determined object to be recognized.

11. An object detection apparatus for recognizing an object from input data, the object detection apparatus configured to:
a) carry out raw detections in which at least two objects are determined;
b) determine at least one relational attribute for the at least two objects, the at least one relational attribute defining a relationship between the at least two objects; and
c) determine an object to be recognized based on the at least one relational attribute.

12. The object detection apparatus according to claim 11 further comprising:
a neural network configured to at least partly perform at least one of the a) carrying out the raw detections, the b) determining the at least one relational attribute, and the c) determining the object to be recognized.

13. The method according to claim 1, wherein the method is carried out by executing, with a computer, instructions of a computer program stored on a computer-readable storage medium.

14. The method according to claim 6, wherein the neural network is a convolutional neural network configured to convolve an image of the input data with a defined frequency at least in partial regions using convolutional kernels.

15. The method according to claim 8, wherein the physical system is a vehicle.
